(19) United States
(12) Patent Application Publication
(10) Pub. No.: US 2012/0204235 A1
(43) Pub. Date: Aug. 9, 2012

(54) Updating Resource Access Permissions in a Virtual Computing Environment

(76) Inventors: Joe Jaudon, Sedalia, CO (US); David Lowrey, Denver, CO (US); Adam Williams, Aurora, CO (US)

(21) Appl. No.: 13/368,836

(22) Filed: Feb. 8, 2012

Related U.S. Application Data
(60) Provisional application No. 61/440,724, filed on Feb. 8, 2011.

(51) Int. Cl. G06F 21/20

(52) U.S. Cl. 726/4

(57) ABSTRACT

Methods, systems, and devices are described for updating resource access permissions in a virtual computing environment. In these methods, systems, and devices, a host computer system determines that a user associated with an existing session has moved from a first location associated with a first set of access permissions to a second location associated with a second set of access permissions. The second set of access permissions is applied at the host computer to the existing session based on the determination that the user has moved to the second location. The user is then allowed to access the existing session from the second location according to the second set of access permissions.

CROSS REFERENCES

The present application claims priority from U.S. Provisional Patent Application Ser. No. 61/440,724, entitled “UPDATING RESOURCE ACCESS PERMISSIONS IN A VIRTUAL COMPUTING ENVIRONMENT” and filed on Feb. 8, 2011, which is incorporated herein by reference in its entirety for all purposes.

### BACKGROUND

The present invention relates to computer network communication, and more particularly, to updating resource access permissions in a virtual computing environment.

Various computer systems may use a thin-client or a virtual desktop display in conjunction with a centralized server computer system or mainframe. Virtualization is a logical representation of a computer in software. By decoupling the physical hardware from aspects of operation, virtualization may provide more operational flexibility and increase the utilization rate of the underlying physical hardware. Although virtualization is implemented primarily in software, many modern microprocessors now include hardware features explicitly designed to improve the efficiency of the virtualization process.

A virtual desktop display can be served to client devices from a central or distributed server computer system. The server may receive input and output over a network or other communication medium established between the device and the server. In some examples, a thin-client device may run web browsers or remote desktop software, such that significant processing may occur on the server.

In many instances, roaming users may have different application needs when they move to new locations, or there may be a range of privacy or use concerns in different locations. Thus, there may be a need in the art to create mechanisms that provide users with dynamically changing access permissions as they roam.

### SUMMARY

Methods, systems, devices, and computer program products are described for dynamically modifying access permissions as users roam in a virtual computing environment.

In a first set of embodiments, a system for implementing a virtual computing environment includes a host computer system and a client device. The host computer system is configured to determine that a user associated with an existing session has moved from a first location associated with a first set of access permissions to a second location associated with a second set of access permissions, apply the second set of access permissions to the existing session based on the determination that the user has moved to the second location, and allow the user to access the existing session from the second location according to the second set of permissions. The client device is configured to communicate with the host computer system to provide a user interface to the existing session for the user at the second location.

In a second set of embodiments, a method of updating resource access permissions in a virtual computing environment includes determining at a host computer system that a user associated with an existing session has moved from a first location associated with a first set of access permissions to a second location associated with a second set of access permissions. The second set of access permissions are applied at the host computer system to the existing session based on the determination that the user has moved to the second location. The user is permitted to access the existing session from the second location according to the second set of access permissions.

In a third set of embodiments, a host computer system includes a location identification module, an access permission module, and a session module. The location identification module is configured to determine that a user associated with an existing session has moved from a first location associated with a first set of access permissions to a second location associated with a second set of access permissions. The access permission module is configured to apply the second set of access permissions to the existing session based on the determination that the user has moved to the second location. The session module is configured to allow the user to access the existing session from the second location according to the second set of access permissions.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram of an example system including components configured according to various embodiments of the invention.

FIG. 2 is a block diagram of an example system including components configured according to various embodiments of the invention.

FIG. 3 is a block diagram of an example system including components configured according to various embodiments of the invention.

FIG. 4 is a block diagram of an example system including components configured according to various embodiments of the invention.

FIG. 5A is a block diagram of an example host central server computer system including components configured according to various embodiments of the invention.

FIG. 5B is a block diagram of an example host central server computer system including components configured according to various embodiments of the invention.

FIG. 6 is a flowchart diagram of an example method of updating resource access permissions in a virtual computing environment, according to various embodiments of the invention.

FIG. 7 is a flowchart diagram of an example method of updating resource access permissions in a virtual computing environment, according to various embodiments of the invention.

FIG. 8 is a flowchart diagram of an example method of updating resource access permissions in a virtual computing environment, according to various embodiments of the invention.

FIG. 9 is a schematic diagram that illustrates a representative device structure that may be used in various embodiments of the present invention.

### DETAILED DESCRIPTION OF THE INVENTION

Methods, systems, devices, and computer program products are described for dynamically modifying access permissions as user roam in a virtual computing environment. User movement during a session may be monitored, and access permissions related to the session may be adapted for a changed location. There may be varying rules for access permissions at different locations. When a roaming user with an existing session signs in to the session at a changed location, actions may be taken dynamically so that the access permissions reflect the changed location.

This description provides examples only, and is not intended to limit the scope, applicability, or configuration of the invention. Rather, the ensuing description of the embodiments will provide those skilled in the art with an enabling description for implementing embodiments of the invention. Various changes may be made in the function and arrangement of elements without departing from the spirit and scope of the invention from the beginning of the access period.

Thus, various embodiments may omit, substitute, or add various procedures or components as appropriate. For instance, it should be appreciated that in alternative embodiments the methods may be performed in an order different from that described, and that various steps may be added, omitted, or combined. Also, features described with respect to certain embodiments may be combined in various other embodiments. Different aspects and elements of the embodiments may be combined in a similar manner.

It should also be appreciated that the following systems, methods, devices, and software may individually or collectively be components of a larger system, wherein other procedures may take precedence over or otherwise modify their application. Also, a number of steps may be required before, after, or concurrently with the following embodiments.

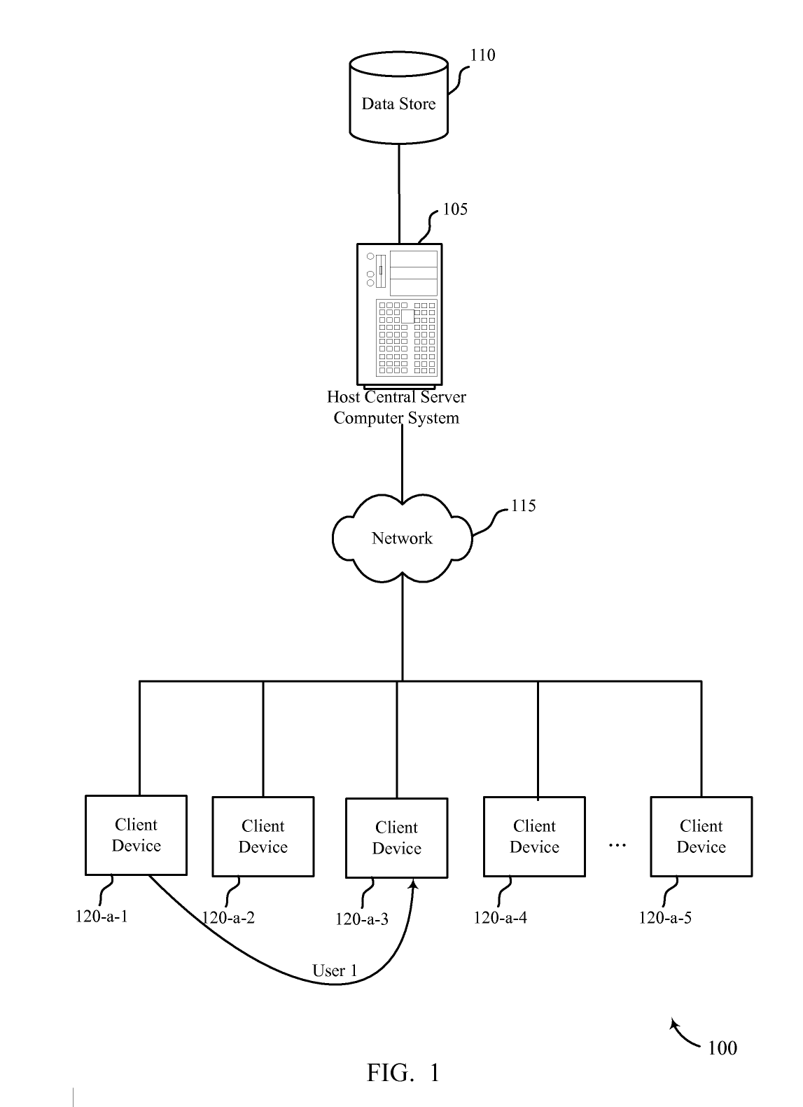

Systems, devices, methods, and software are described for a virtual computing environment. In one set of embodiments, shown in FIG. 1, system 100 includes a host central server computer system 105, data store 110, network 115, and client devices 120. Each of these components may be in communication with each other, directly or indirectly.

The host central server computer system 105 may be configured to run sessions of a virtual computing environment for one or more users, and the session may be allowed to roam with a user as he or she moves between client devices 120. In some embodiments, some of the functions of the host central server computer system 105 in this process may be distributed to or among the client devices 120. The host central server computer system 105 may control the application of different access permissions for users (or user types) at differing locations. The host central server computer system 105 may serve a session to specific client devices 120 in the network, while dynamically modifying access permissions based on location. As used herein, a virtual computing environment includes any network whereby KVM (keyboard, video, and mouse) functionality is decoupled from the computer(s) serving the session through techniques of virtualization. As used herein, the term “session” refers to hosted session of a virtual computing environment that may be accessed from one or more client devices. For example, a session may include a thin client session, a virtual application session, a virtual machine session, a virtual operating system session, and/or the like.

The host central server computer system 105 may include a session manager and rules engine to allocate and manage sessions (and their related access permissions) within the network. The host central server computer system 105 may be made up of one or more server computers, workstations, web servers, or other suitable computing devices. The host central server computer system 105 may be fully located within a single facility or distributed geographically, in which case a network may be used to integrate different components. Although the illustrated embodiment shows that a host central server computer system 105 performs the allocation and management, in other examples these functions may be performed by a virtual server, resident in whole or in part on one of the client devices 120, or distributed among client devices 120. A client device 120 may be a personal computer, laptop, tablet, personal digital assistant (PDA), thin client, mobile device, cellular telephone, medical equipment or device, or any other computing device, and may have wired or wireless connections.

The rules for allocating sessions, monitoring sessions, generating rules for access permissions, and applying rules for access permissions may be stored locally by the host central server computer system 105, or may be stored (in whole or in part) at data store 110. Data store 110 may be a single database, or may be made up of any number of separate and distinct databases. The data store 110 may include one, or more, relational databases or components of relational databases (e.g., tables), object databases, or components of object databases, spreadsheets, text files, internal software lists, or any other type of data structure suitable for storing data. Thus, it should be appreciated that a data store 110 may each be multiple data storages (of the same or different type), or may share a common data storage with other data stores. Although in some embodiments the data store 110 may be distinct from a host central server computer system 105, in other embodiments it may be integrated therein to varying degrees.

In some examples, a host central server computer system 105 monitors user sessions (e.g., via direct monitoring or via reports from client devices 120). To initiate a session, a user may log on to a client device 120-a-1 by presenting authentication credentials (e.g., a user name, password, key card, key fob, and/or biometric sign-in, etc.), and the client device 120-a-1 may transmit the authentication credentials or other information to the host central server computer system 105. The host central server computer system 105 may direct a session to be started. At this time, the user may be granted certain access permissions for the session (e.g., access permissions to drives, directories, folders, files, applications, etc.). These access permissions may be based on the location of the client device 120-a-1 (e.g., and also be based on user type, computer type, session type, etc.).

When a user logs out, the session may be maintained (e.g., for a system specified time period, a user-specified time period, a user specific time period, or indefinitely). The user may then attempt to log on to a different client device 120-a-3 (e.g., with a user name, password, key card, key fob, and/or biometric sign-in, etc.), and the client device 120-a-1 may query the host central server computer system 105 about the user and retrieve information about the session.

The host central server computer system 105 may identify the user, the session, and the location of the client device 120-a-1 (e.g., identifying location, the specific client device 120-a-1, and the type of client device 120-a-1). There may be location-specific rules for access permissions applicable to individual users, types of users, sessions, types of sessions, applications, specific client devices, types of devices, etc. The location-specific rules may apply to a particular client device, all client devices in an area, or certain types of client devices in an area. The access permission rules may relate to controlling, restricting, manipulating, or restricting resources. Resources may include applications, computing resources (e.g., CPU, memory, etc.), network resources (e.g., networks, domains, subnets, etc.), and system resources (e.g., peripheral devices, drives, folders, directories, files, etc.).

Various types of action may be initiated according to the one or more access permission rules. In certain examples, the action may be to allow or block access to a resource, such as, for instance, a folder in a network drive, an application, and/or a network. In additional or alternative examples, the action may be to create, open, close, or delete an application, a file, a user profile, a setting, or the like. In still other additional or alternative examples, the action may be to open or hide a certain aspect of the session. For instance, an application associated with the session may continue to run in the background, but the access permission rule may hide the application from the user, thereby preventing the user from viewing or access the running application through the session. Additionally or alternatively, the action may affect some other aspect of the user interface of the session, such as minimizing or maximizing a certain application, file, or folder; reordering the display of graphical elements in the session; moving graphical elements in the session; drawing certain graphical elements in the session; painting certain graphical elements in the session; filling certain graphical elements in the session; clearing certain graphical elements in the session; and/or coloring certain graphical elements in the session.

In additional or alternative examples, the action initiated according to the one or more access permission rules may include displaying certain text or graphics to the user, prompting the user to provide textual or other input to the session, and/or initiating communications via input/output (I/O) devices or ports.

The host central server computer system 105 may identify any location-specific access permission rules applicable to the log-on to client device 120-a-3, and initiate actions according to the rules. The host central server computer system 105 may authenticate the user, and serve the session to client device 120-a-3, while noting that these steps may each take place while the access permission rule implementation is already underway to modify the session (e.g., opening or closing applications, hiding or revealing information, etc.).

Thus, the host central server computer system 105 may follow individual sessions, and detect when an access permission rule is triggered by monitoring user movement. The host central server computer system 105 may call up the resultant action, and either modify the session or transmit modification information accordingly. Using this information, sessions can be adapted dynamically to account for varying user access permissions to resources at different locations.

The components of the system 100 may be directly connected, or may be connected via a network 115 which may be any combination of the following: the Internet, an IP network, an intranet, a wide-area network (“WAN”), a local-area network (“LAN”), a virtual private network, the Public Switched Telephone Network (“PSTN”), or any other type of network supporting data communication between devices described herein, in different embodiments. The network 115 may include both wired and wireless connections, including optical links. Many other examples are possible and apparent to those skilled in the art in light of this disclosure. In the discussion herein, a network may or may not be noted specifically. If no specific means of connection is noted, it may be assumed that the link, communication, or other connection between devices may be via a network.

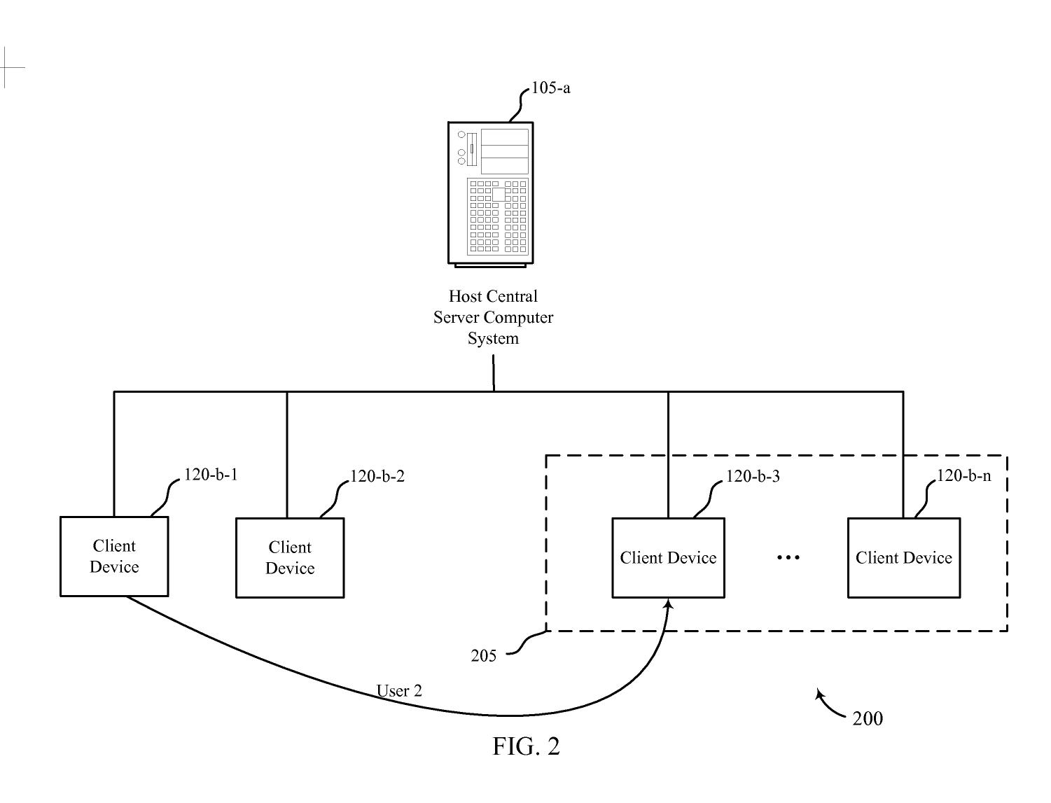

Turning next to FIG. 2, this diagram illustrates a system 200 which includes a host central server computer system 105-a and client devices 120. This system 200 may be an example of the system 100 of FIG. 1, and the host central server computer system 105-a may be the host central server computer system 105 of FIG. 1. Each of these components may be in communication with each other, directly or indirectly. At an initial period of time, user 2 may log onto client device 120-b-1. The client device 120-b-1 may query the host central server computer system 105-a about the user, and the host central server computer system 105-a may authenticate the user and check to see if the user has a current session running The host central server computer system 105-a may direct a session to be started, and the KVM function of the session may be provided to the client device 120-b-1 to which user 2 logged in. User 2 may be granted various location-specific access permissions applicable to the client device 120-b-1. In certain examples, the location-specific access permissions may be a location-based subset of a global set of access permissions applicable to the client device 120-b-1 or the user 2. In this example, the location-specific access permission rules are region-specific rules. Thus, access permission rules are applicable to certain regions (e.g., to certain rooms, types of rooms, floors, portions of floors, multi-floor areas, regions, etc). User 2 may then log off of client device 120-b-1, moving toward client device 120-b-3.

In response to user 2 logging on to client device 120-b-3, the host central server computer system 105-a may identify the user, the session, and the location 205 within which client device 120-b-3 is located. As noted, there may be region-specific (e.g., area-specific, floor-specific, etc.) access permission rules for individual users, types of users, sessions, types of sessions, applications, devices, types of devices, and types of regions. The access permission rules may specify the control or access (e.g., to drives, directories, files, folders, applications, etc.) allowed at different locations, and these access permissions may be dynamically provided, modified, or taken away based on the changed location. Access levels (e.g., private, view only, view and copy only, full access) may be varied according to these rules. As described in more detail with reference to FIG. 1 above, any or all of the following actions may be undertaken according to a region-specific access permission rule: create, hide, close, minimize, maximize, normalize, reorder, draw, paint, line, text, color, fill, clear, move, keyboard input, direct i/o, delete, open, execute, auto-launch, and/or kill.

The host central server computer system 105-a may identify any user-specific or user type-specific access permission rules applicable to the determination that user 2 is within location 205-b, and initiate actions according to the region-specific access permission rules. The user type-specific access permission rules and/or the region-specific access permission rules may be subsets of the aforementioned global set of access permissions identified for the user when the session is initiated. These actions may be initiated before the user has signed-in completely. The host central server computer system 105-a and/or client device 120-b-3 may query user 2 for additional authentication factors (e.g., a password), while the access permission actions have already been initiated.

Thus, in one example, user 2 may provide a first authentication credential (e.g., username, access card token, biometric token, etc.) to client device 120-b-3. Prior to allowing user 2 to access his or her existing session, the host central server computer system 105-a may identify user 2 from the first authentication credential, identify the applicable access permission rules, and initiate actions associated with enforcing the access permissions rules. A second authentication credential (e.g., password, PIN, etc.) provided by user 2 at client device 120-b-3 may then be accepted, the host central server computer system 105-a may complete authenticating user 2, and user 2 may be allowed to access his or her session via client device 120-b-3, subject to the access permission rules associated with location 205-b.

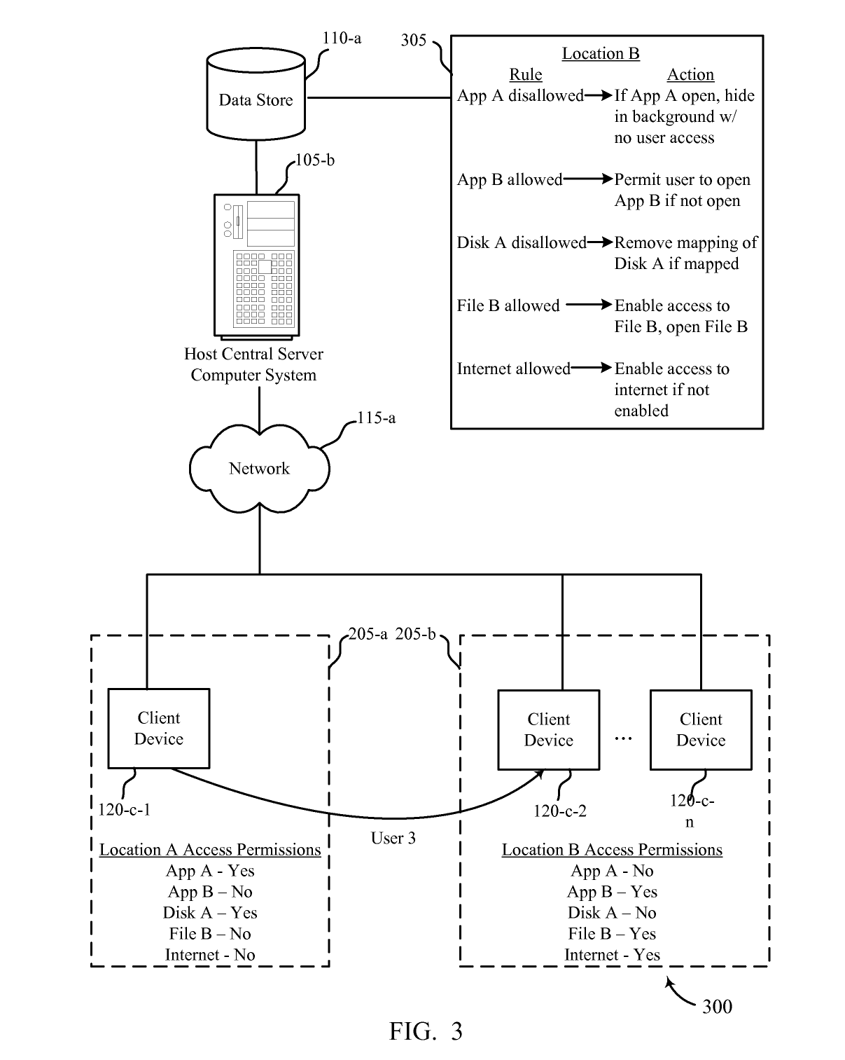

FIG. 3 is a block diagram illustrating another example of user movement between different locations in a system 300. The system 300 of the present example includes host central server computer system 105-b, data store 110-a, network 115-a, and client devices 120. Each of these components may be in communication, directly or indirectly. The system 300 may be an example of the system 100 described above with reference to FIG. 1 and/or the system 200 described above with reference to FIG. 2.

As shown in FIG. 3, the client devices 120 may be distributed between two locations 205. Client device 120-c-1 is associated with location 205-a, while client device 120-c-2 and client device 120-c-n are associated with location 205-b. In additional or alternative embodiments, one or more client devices 120 may be associated with other locations 205 (not shown). Each location 205 may be associated with a set of access permissions. The set of access permissions associated with each location 205 may vary with different users or may remain static for all users. In certain examples, the set of access permissions associated with a location 205 may include one or more permissions applicable to all users within that location 205 and one or more permissions that vary throughout the location according to the identity of a user, the identity of a client device 120, and/or any other relevant factor.

In the present example, User 3 may initially log on to client device 120-c-1 at location 205-a. One or more authentication credentials may be provided by user 3 at client device 120-c-1 to initiate a session, and client device 120-c-1 may forward the authentication credential(s) to host central server computer system 105-b for authentication of user 3. In connection with the authentication of user 3 at client device 120-c-1, the host central server computer system 105-b may initiate a new session associated with user 3, and client device 120-c-1 may provide KVM functionality to the session over the network 115-a.

The host central server computer system 105-b may enforce a set a set of access permissions with regard to the session initiated for user 3. In certain examples, the host central server computer system 105-b may determine the location 205-a of client device 120-c-1, retrieve the set of access permissions associated with the location 205-a, and apply the set of access permissions to the newly created session. The location 205-a of client device 120-c-1 may be known to host central server computer system 105-b, provided to host central server computer system 105-b by client device 120-c-1, and/or dynamically determined by host central server computer system 105-b using any number of known techniques.

The set of access permissions may include a number of access permissions that are associated with the location 205-a. The set of access permissions associated with location 205-a may include one or more permissions that are globally applicable to all users at location 205-a, one or more permissions that are applicable to a specific subset of users at location 205-a, and/or one or more permissions specific only to user 3 at location 205-a. In certain examples, the set of access permissions may also include one or more access permissions that are not specifically tied to or associated with any particular location 205-a.

As shown in the example of FIG. 3, the set of access permissions applicable to user 3 at location 205-a includes: 1) permission to access application A, 2) a lack of permission to access application B, 3) permission to access disk A, 4) a lack of permission to access file B, and 5) a lack of permission to access the Internet. Thus, while the session for user 3 may be hosted by the host central server computer system 105-b at a fixed location, the access permissions given to user 3 in the session are based at least partially on the actual location of user 3.

As further shown in FIG. 3, user 3 may log off of client device 120-c-1 and physically move to location 205-b. After user 3 has logged off of client device 120-c-1, the session generated for user 3 may be maintained by host central server computer system 105-b (e.g., for a specified period of time, until a predetermined trigger event occurs, or indefinitely). In this way, when user 3 logs on to client device 120-c-2 in location 205-b, a new session need not be built from scratch. Rather, the KVM functionality for the existing session already associated with user 3 may be switched to client device 120-c-2.

However, a different set of access permissions may apply to user 3 at location 205-b than applied to user 3 at location 205-a. As shown in FIG. 3, the access permissions applicable to user 3 at location 205-b include: 1) a lack of permission to access application A, 2) permission to access application B, 3) a lack of permission to access disk A, 4) permission to access file B, and 5) permission to access the Internet. The host central server computer system 105-b may therefore apply the set of access permissions associated with location 205-b to the existing session for user 3 in connection with user 3 logging on to client device 120-c-2. In certain examples, host central server computer system 105-b may prevent the user 3 from accessing the existing session until the new set of access permissions has been applied to the session.

The first step in applying the set of access permissions associated with location 205-b to the existing session for user 3 involves host central server computer system 105-b determining that user 3 has moved from location 205-a, which is associated with a first set of access permissions, to location 205-b, which is associated with a second set of access permissions. In response to this determination, host central server computer system 105-b may retrieve a set of rules 305 associated with the access permissions applicable to user 3 at location 205-b from data store 110-a. The set of rules 305 may be distinguished from the set of permissions in that each rule is associated with one or more actions designed to enforce the permissions. These actions may be conditional. Host central server computer system 105-b may perform one or more of the actions associated with the rules 305 with respect to the existing session for user 3 to enforce or otherwise implement the set of access permissions applicable to user 3 at location 205-b.

In the example of FIG. 3, a first rule provides that access to application A is disallowed while user 3 is at location 205-b. The action associated with the first rule, if application A is currently running in the session, is to hide application A from the user interface of the session while running application A in the background. Additionally or alternatively, if application A is not currently running in the session, the action associated with the first rule may be to prevent user 3 from initiating application A while user 3 is at location 205-b. A second rule may provide that user 3 is allowed to access application B while user 3 is at location 205-b. The action associated with the second rule may include permitting user 3 to open application B if application B is not already open. A third rule may provide that user 3 is not allowed to access disk A at location 205-b. The action associated with the third rule may include, if disk A is currently mapped to the session, removing or hiding the mapping of disk A from the session while user 3 is at location 205-b. A fourth rule may provide that user 3 is permitted to access file B at location 205-b. The action associated with the fourth rule may include enabling access to file B and opening file B in the user interface of the session. A fifth rule may provide that user 3 is permitted to access the internet at location 205-b. The action associated with the fifth rule may include, if internet connectivity is not already enabled for the session, enabling internet connectivity for the session.

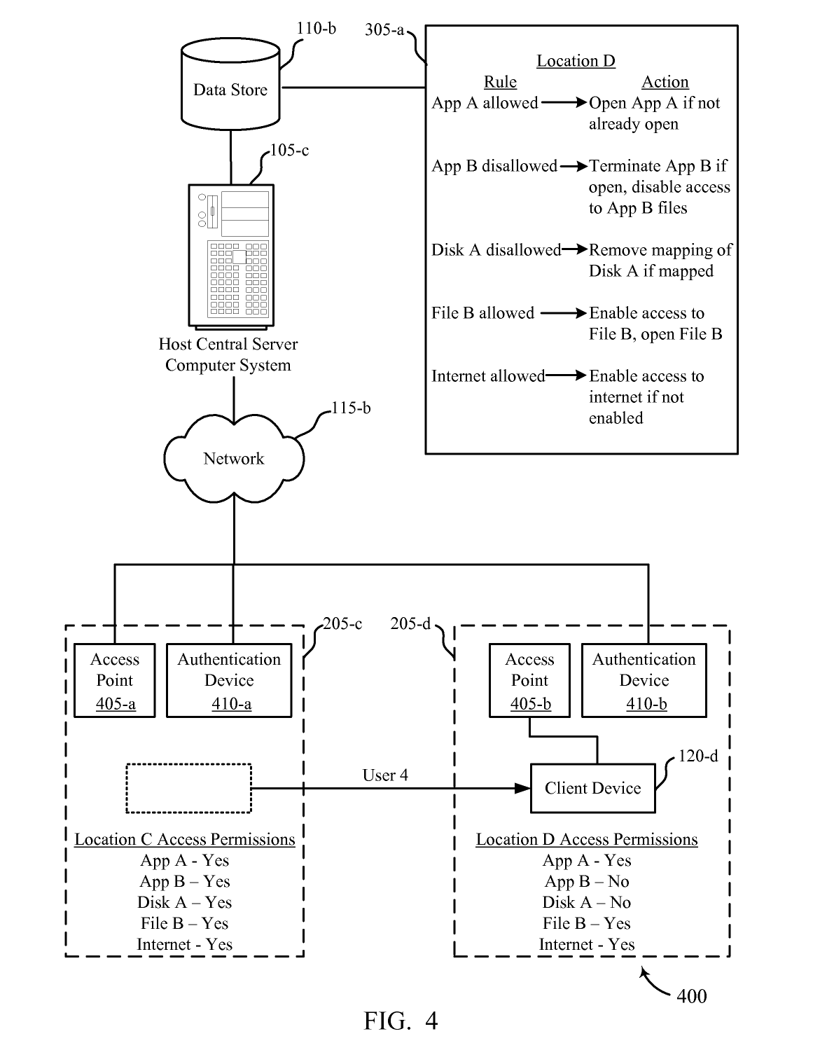

FIG. 4 is a block diagram illustrating another example of user movement between different locations in a system 400. The system 400 of the present example includes host central server computer system 105-c, data store 110-b, network 115-b, access points 405, authentication devices 410, and client device 120-d. Each of these components may be in communication, directly or indirectly. The system 400 may be an example of the system 100 described above with reference to FIG. 1, the system 200 described above with reference to FIG. 2, and/or the system 300 described above with reference to FIG. 3.

In the example of FIG. 4, one or more access points 405-a may be disposed at each location 205 to provide access to network 115-b. Additionally, in certain examples, one or more authentication devices 410 may be disposed at each location 205 to receive authentication credentials from users and initiate action based on the received credentials. The location of one or more access points 405 and/or authentication devices 410 may be known or ascertainable by host central server computer system 105-c.

In the present example, user 4 may log on to portable client device (e.g., smartphone, tablet computer, laptop, etc.) 120-d at location 205-c to initiate a session hosted by host central server computer system 105-c and move with the client device 120-d to location 205-d. As shown in the Figure, differences exist between a set of access permissions associated with location 205-c and a set of access permissions associated with location 205-d. For example, user 4 is permitted to access application B and disk A at location 205-c, but not at location 205-d.

Host central server computer system 105-c may determine that user 4 has moved from location 205-c to location 205-d in a number of ways. In one example, host central server computer system 105-c may determine that client device 120-d has moved from access point 405-a to access point 405-b for access to network 115-b. Using the known location of access point 405-b, host central server computer system 105-c may extrapolate that client device 120-d, and by extension, user 4, is now at location 205-d. Additionally or alternatively, user 4 may provide authentication credentials (e.g., a key card token, PIN, username, password, biometric token, etc.) at authentication device 410-b to gain access to a room, a piece of equipment, and/or to regain access to the existing session on client device 120-d. Using the known location of the authentication device 410-b, host central server computer system 105-c may extrapolate that user 4 is now at location 205-d.

In response to the determining that client device 120-d has now moved to location 205-d, host central server computer system 105-c may retrieve a set of rules 305-a associated with the access permissions applicable to user 4 at location 205-d from data store 110-b. Host central server computer system 105-d may perform one or more actions associated with the rules 305-a with respect to the existing session for user 4 to enforce or otherwise implement the set of access permissions applicable to user 4 at location 205-b.

In the example of FIG. 4, a first rule provides that access to application A is allowed while user 4 is at location 205-d. The action associated with the first rule, if application A is not currently running in the session, is to automatically open application A in the session. A second rule may provide that user 4 is not allowed to access application B while user 4 is at location 205-d. The action associated with the second rule may include automatically terminating application B in the session if application B is currently running, and/or preventing user 4 from opening application B while user 4 is known to be at location 205-d. A third rule may provide that user 4 is not allowed to access disk A at location 205-d. The action associated with the third rule may include, if disk A is currently mapped to the session, removing or hiding the mapping of disk A from the session while user 4 is at location 205-d. A fourth rule may provide that user 4 is permitted to access file B at location 205-d. The action associated with the fourth rule may include enabling access to file B and opening file B in the user interface of the session. A fifth rule may provide that user 4 is permitted to access the internet at location 205-d. The action associated with the fifth rule may include, if internet connectivity is not already enabled for the session, enabling internet connectivity for the session.

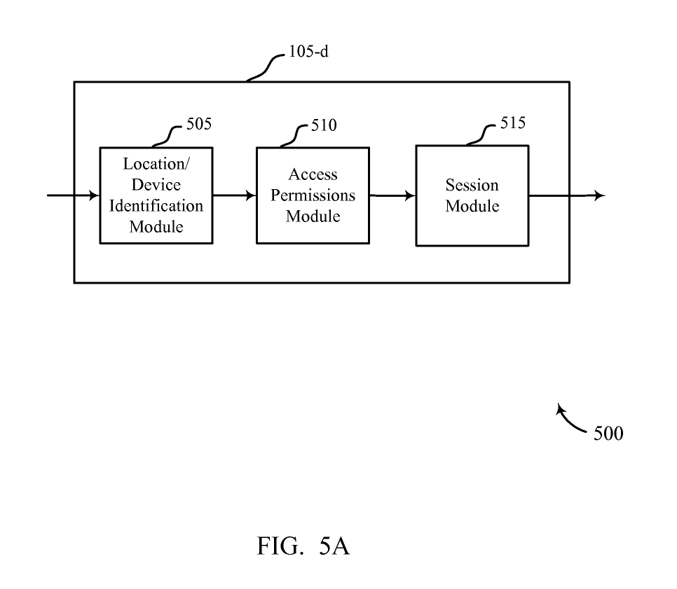

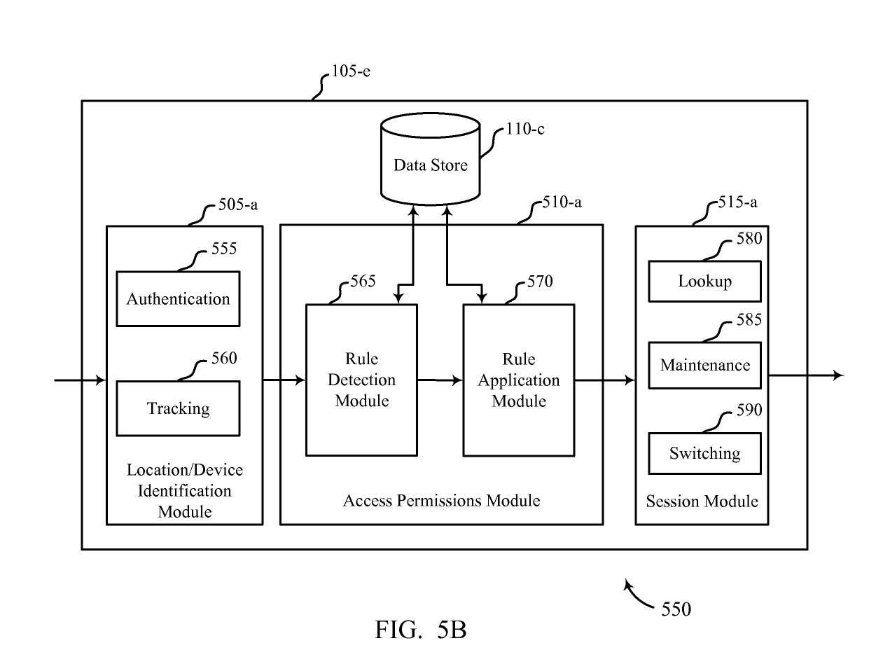

FIG. 5A is a block diagram 500 illustrating an example of host central server computer system 105-d, which may be the host central server computer system 105 described above with reference to FIG. 1, FIG. 2, FIG. 3, and/or FIG. 4. The host central server computer system 105-d may receive queries from client devices in a network (e.g., initiated when a user logs in), and allocate and manage sessions based on the queries. The host central server computer system 105-d may include a location/device identification module 505, an access permissions module 510, and a session module 515. Each of these components may be in communication, directly or indirectly. In other examples, any other suitable type of host device or client device may have any subset of this functionality.

The location/device identification module 505 may be configured to determine that a user associated with an existing session on the host central server computer system 105-d has moved from a first location associated with a first set of access permissions to a second location associated with a second set of access permissions. As described previously, the location/device identification module 505 may identify the location of the user through a number of ways.

The user location may, for example, be identified based on the known location of client devices used by the user to access the existing session. Additionally or alternatively, the user location may be identified based on the known location of an access point, wireless router, and/or authentication device used by the user or by a client device associated with the user. In still other examples, other methods of identifying the location of the user may be employed, including, for example, requesting the location from the user, identifying a location of the user device through Global Positioning Service (GPS) and/or wireless triangulation. By monitoring the location of the user, the location/device identification module 505 may detect when the user moves from the first location associated with the first set of access permissions to the second location associated with the second set of access permissions.

The access permissions module 510 may be configured to apply the second set of access permissions associated with the current location of the user to the existing session for the user based on the determination that user has moved to the second location. In certain examples, applying the second set of access permissions may include retrieving a set of rules from a data store and initiating actions associated with the rules to the existing session to implement the second set of access.

The session module 515 may be configured to manage the sessions hosted by the host central server computer system 105-d for the users. The session module 515 may implement functionality for initiating virtual computing sessions, enforcing rules and settings, storing and applying user profiles, executing and terminating applications, providing access to files, and the like. For example, after the access permissions module 510 has applied the second set of permissions to the existing session for a user who has moved to the second location, the session module 515 may allow the user to access the existing session from the second location according to the second set of access permissions.

FIG. 5B is a block diagram 550 of another example of a host central server computer system 105-e, which may be the host central server computer system 105 described above with reference to FIG. 1, FIG. 2, FIG. 3, FIG. 4, and/or FIG. 5A. The host central server computer system 105-e may receive queries from client devices in a network (e.g., initiated when a user logs in), and allocate and manage sessions based on the queries. The host central server computer system 105-e may include a location/device identification module 505-a, an access permissions module 510-a, and a session module 515-a, which may be examples of the location/device identification module 505, the access permissions module 510, and the session module 515 described above with reference to FIG. 5A. Each of these components may be in communication, directly or indirectly. In other examples, any other suitable type of host device or client device may have any subset of this functionality.

In some examples, the location/device identification module 505-a monitors the location of users having existing sessions hosted by the session module 515-a (e.g., via direct monitoring or via reports from client devices (e.g., client devices 120 of FIGS. 1-4). To initiate a session, a user may log on to a client device by transmitting authentication credentials (a user name, password, key card, key fob, and/or biometric sign-in, etc.) to the host central server computer system 105-e. An authentication submodule 555 may receive the authentication credentials and verify the identity of the user. The session module 515-a of the host central server computer system 105-e may direct a session to be started for that user. Based on location-specific access permissions, the user may have certain access permissions (e.g., access to files, folders, directories, drives, or applications). When the user logs out, the session (and access permissions) may be maintained (e.g., for a system specified time period, a user-specified time period, a user specific time period, or indefinitely). The user may then roam.

A tracking submodule 560 of the location/device identification module 505-a may monitor the movement of the user (e.g., monitoring the system for a possible sign-in). Rule detection module 565 of access permissions module 510-a may identify the user, the session, and a rule triggering event (e.g., attempted sign-on). There may be access permission rules stored in rules data store 110-a for individual users, types of users, sessions, types of sessions, applications, computers, types of computers, locations, types of locations, and transitions between certain locations. The access permission rules may specify the control or access (e.g., to drives, directories, files, folders, applications, etc.) allowed at different locations, and these access permissions may be dynamically provided, modified, or taken away based on the changed location. Access levels (e.g., private, view only, view and copy only, full access) may be varied according to these rules.

The rule detection module 565 may identify any user-specific or user type-specific access permission rules applicable to a log-on at that location and, for example, retrieve the access permission rules from a rules data store 110-c. The rule application submodule 570 may initiate actions associated with the access permission rules to apply the set of access permission rules associated with the user based at least in part on the location of the user.

These actions may occur in response to the determination that the user has moved to the new location. For example, at least one action may be initiated during the authentication of the user at the new location. The user may be prevented from accessing his or her session until the actions have completed and the access permissions are fully applied to the session. These actions may change the applicable access permissions for a session before the user is given access to the session at a new location, to thereby dynamically reflect the rules of the new location. Examples of such actions include, but are not limited to, allowing the user to access a system resource based on the location of the user, preventing the user from accessing a system resource based on the location of the user, opening an application associated with the session based on the location of the user; and/or closing an application associated with the session based on the location of the user.

In the present example, the session module 515-a may include a lookup submodule 580 configured to provide requested information about a particular session or user, a maintenance submodule 585 configured to maintain the sessions, and a switching submodule 590 configured to switch KVM functionality between existing sessions and different client devices as circumstances change.

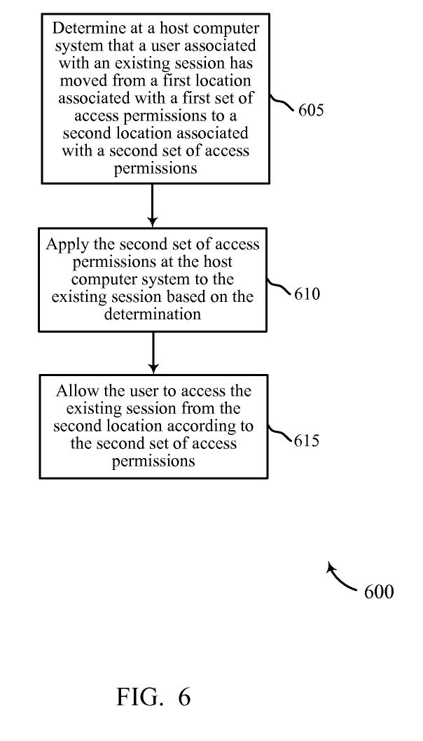

Referring next to FIG. 6, a flow chart is shown illustrating a method 600 for updating resource access permissions in a virtual desktop environment. This method 600 may, for example, be performed in whole or in part by the system 100 of FIG. 1, the system 200 of FIG. 2, the system 300 of FIG. 3, the system 400 of FIG. 4, or the host central server computer system 105 of FIG. 1, FIG. 2, FIG. 3, FIG. 4, FIG. 5A, or FIG. 5B.

At block 605, it is determined at a host computer system (e.g., host central sever computer system 105) that a user associated with an existing session has moved from a first location associated with a first set of access permissions to a second location associated with a second set of access permissions. At block 610, the second set of access permissions is applied at the host computer system to the existing session based on the determination that the user has moved to the second location.

In certain examples, applying the second set of access permissions to the existing session includes retrieving at least one access permission rule associated with the second location from a data store and applying the at least one access permission rule to the existing session. The at least one access permission rule may be associated with an action, and the action may be initiated with respect to the existing session at the host computer system in response to the determination that the user has moved to the second location. Examples of the at least one action may include, but are not limited to, allowing the user to access a system resource based on the second location, preventing the user from accessing a system resource based on the second location, and/or opening or closing an application associated with the session based on the second location. In certain examples, the user is authenticated at the second location, and the at least one action is initiated during the authentication of the user at the second location.

At block 615, the user is allowed to access the existing session from the second location according to the second set of access permissions. In certain examples, the user may be prevented from accessing the session at the host computer system until after the at least one action associated with the aforementioned at least one access permission rule has completed.

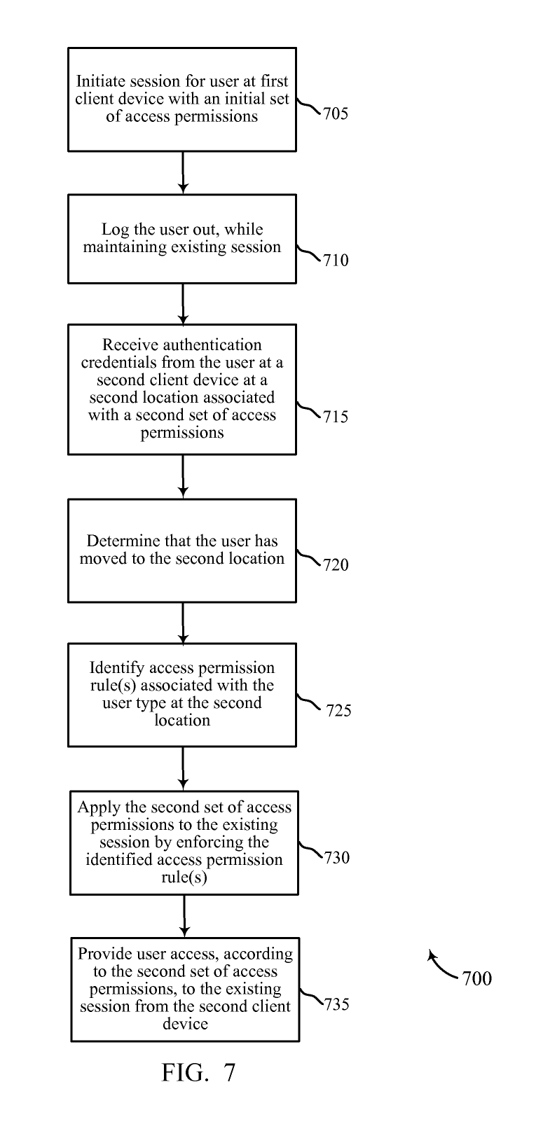

Referring next to FIG. 7, a flow chart is shown illustrating an alternative method 700 for updating resource access permissions in a virtual desktop environment. This method 700 may, for example, be performed in whole or in part by the system 100 of FIG. 1, the system 200 of FIG. 2, the system 300 of FIG. 3, the system 400 of FIG. 4, or the host central server computer system 105 of FIG. 1, FIG. 2, FIG. 3, FIG. 4, FIG. 5A, or FIG. 5B.

At block 705, a session for a user is initiated at a first client device with initial access permissions. At block 710, the user is logged out of the first client device, and the existing session is maintained at the host computer system. At block 715, authentication credentials are received from the user at a second client device at a second location associated with a second set of access permissions. At block 720, a determination is made that the user has moved to the second location based on the determination that the user has logged onto the second client device. At block 725, an access permission rule associated with the user type at the second location is identified. At block 730, the second set of access permissions for the existing session are applied to the existing session by enforcing the identified access permission rules. At block 735, the user is provided access to the existing session from the second client device according to the second set of access permissions.

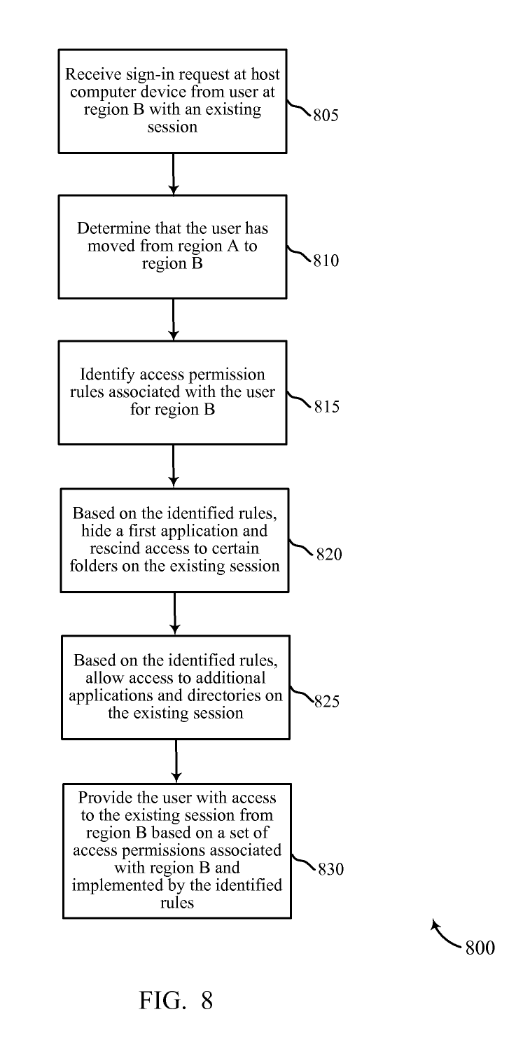

Referring next to FIG. 8, a flow chart is shown illustrating another method 800 for updating resource access permissions in a virtual desktop environment. This method 800 may, for example, be performed in whole or in part by the system 100 of FIG. 1, the system 200 of FIG. 2, the system 300 of FIG. 3, the system 400 of FIG. 4, or the host central server computer system 105 of FIG. 1, FIG. 2, FIG. 3, FIG. 4, FIG. 5A, or FIG. 5B.

At block 805, a sign-in request is received at a host computer system from a user at region B associated with an existing session. At block 810, a determination is made that the user has moved from region A to region B. At block 815, access permission rules associated with a set of access permissions for the user for region B are identified. At block 820, a first application is hidden and access to certain folders is rescinded for the existing session based on the identified rules. At block 825, access to additional applications and directories is allowed for the existing session based on the identified rules. At block 830, the user is provided with access to the existing session from region B based on the set of access permissions associated with region B as implemented by the identified rules.

The functionality of the host central server computer system 105 of FIG. 1, FIG. 2, FIG. 3, FIG. 4, FIG. 5A, or FIG. 5B; the location/device identification module of 505 of FIG. 5A or FIG. 5B; the access permissions module 510 of FIG. 5A or FIG. 5B; the session module 515 of FIG. 5A or FIG. 5B; and/or the client device 120 of FIG. 1, FIG. 2, FIG. 3, or FIG. 4, may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by one or more general or application-specific processors.

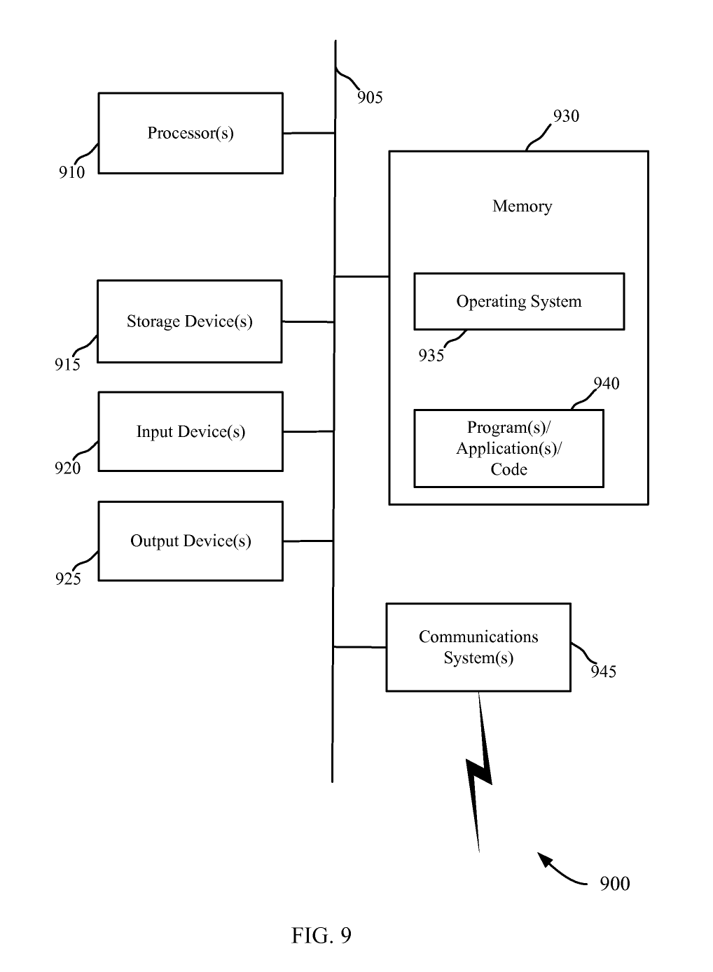

A device structure 900 that may be used for one or more components of host central server computer system 105 of FIG. 1, FIG. 2, FIG. 3, FIG. 4, FIG. 5A, or FIG. 5B, or the client device 120 of FIG. 1, FIG. 2, FIG. 3, or FIG. 4, or for other computing devices described herein, is illustrated with the schematic diagram of FIG. 9. This drawing broadly illustrates how individual system elements of each of the aforementioned devices may be implemented, whether in a separated or more integrated manner. Thus, any or all of the various components of one of the aforementioned devices may be combined in a single unit or separately maintained and can further be distributed in multiple groupings or physical units or across multiple locations. The example structure shown is made up of hardware elements that are electrically coupled via bus 905, including processor(s) 910 (which may further comprise a DSP or special-purpose processor), storage device(s) 915, input device(s) 920, and output device(s) 925. The storage device(s) 915 may be a machine-readable storage media reader connected to any machine-readable storage medium, the combination comprehensively representing remote, local, fixed, or removable storage devices or storage media for temporarily or more permanently containing computer-readable information. The communications system(s) interface 945 may interface to a wired, wireless, or other type of interfacing connection that permits data to be exchanged with other devices. The communications system(s) interface 945 may permit data to be exchanged with a network.

The device structure 900 may also include additional software elements, shown as being currently located within working memory 930, including an operating system 935 and other code 940, such as programs or applications designed to implement methods of the invention. It will be apparent to those skilled in the art that substantial variations may be used in accordance with specific requirements. For example, customized hardware might also be used, or particular elements might be implemented in hardware, software (including portable software, such as applets), or both.

It should be noted that the methods, systems, and devices discussed above are intended merely to be examples. It must be stressed that various embodiments may omit, substitute, or add various procedures or components as appropriate. For instance, it should be appreciated that, in alternative embodiments, the methods may be performed in an order different from that described, and that various steps may be added, omitted, or combined. Also, features described with respect to certain embodiments may be combined in various other embodiments. Different aspects and elements of the embodiments may be combined in a similar manner. Also, it should be emphasized that technology evolves and, thus, many of the elements are examples and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Also, it is noted that the embodiments may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure.

Moreover, as disclosed herein, the term “memory” or “memory unit” may represent one or more devices for storing data, including read-only memory (ROM), random access memory (RAM), magnetic RAM, core memory, magnetic disk storage mediums, optical storage mediums, flash memory devices, or other computer-readable mediums for storing information. The term “computer-readable medium” includes, but is not limited to, portable or fixed storage devices, optical storage devices, wireless channels, a sim card, other smart cards, and various other mediums capable of storing, containing, or carrying instructions or data.

Furthermore, embodiments may be implemented by hardware, software, firmware, middleware, microcode, hardware description languages, or any combination thereof. When implemented in software, firmware, middleware, or microcode, the program code or code segments to perform the necessary tasks may be stored in a computer-readable medium such as a storage medium. Processors may perform the necessary tasks.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Also, a number of steps may be undertaken before, during, or after the above elements are considered. Accordingly, the above description should not be taken as limiting the scope of the invention.

What is claimed is:

1. A system for implementing a virtual computing environment, comprising:
a host computer system configured to:
host a session associated with a user;
determine that a user associated with an existing session has moved from a first location associated with a first set of access permissions to a second location associated with a second set of access permissions;
apply the second set of access permissions to the existing session based on the determination that the user has moved to the second location; and
allow the user to access the existing session from the second location according to the second set of permissions; and
a client device configured to communicate with the host computer system to provide a user interface to the existing session for the user at the second location.

2. The system of claim 1, wherein the host computer system is further configured to:
retrieve at least one access permission rule associated with the second location from a data store;
wherein the applying the second set of access permissions to the existing session comprises applying the at least one access permission rule to the existing session.

3. The system of claim 2, wherein the at least one access permission rule is associated with at least one action, wherein the host computer system is further configured to:
initiate the at least one action with respect to the existing session at the host computer system in response to the determination that the user has moved to the second location.

4. The system of claim 3, wherein the host computer system is further configured to:
authenticate the user at the second location;
wherein the initiating the at least one action with respect to the existing session at the host computer system occurs during the authentication of the user at the second location.

5. The system of claim 3, wherein the host computer system is further configured to:
prevent the user from accessing the session at the host computer system until after the at least one action has completed.

6. A method of updating resource access permissions in a virtual computing environment, comprising:
determining at a host computer system that a user associated with an existing session has moved from a first location associated with a first set of access permissions to a second location associated with a second set of access permissions;
applying the second set of access permissions at the host computer system to the existing session based on the determination that the user has moved to the second location; and
allowing the user to access the existing session from the second location according to the second set of access permissions.

7. The method of claim 6, further comprising:
retrieving at least one access permission rule associated with the second location from a data store; and
wherein the applying the second set of access permissions to the existing session comprises applying the at least one access permission rule to the existing session.

8. The method of claim 7, wherein the at least one access permission rule is associated with at least one action, the method further comprising:
initiating the at least one action with respect to the existing session at the host computer system in response to the determination that the user has moved to the second location.

9. The method of claim 8, wherein the at least one action comprises:
allowing the user to access a system resource based on the second location.

10. The method of claim 8, wherein the at least one action comprises:
preventing the user from accessing a system resource based on the second location.

11. The method of claim 8, wherein the at least one action comprises:
opening an application associated with the session based on the second location.

12. The method of claim 8, wherein the at least one action comprises:
closing an application associated with the session based on the second location.

13. The method of claim 8, further comprising:
authenticating the user at the second location;
wherein the initiating the at least one action with respect to the existing session at the host computer system occurs during the authentication of the user at the second location.

14. The method of claim 8, further comprising:
preventing the user from accessing the session at the host computer system until after the at least one action has completed.

15. The method of claim 6, further comprising:
initiating the existing session at the host computer system in response to the user logging on to a first client device.

16. The method of claim 15, wherein the determining that the user has moved to the second location comprises:
determining at the host computer system that the user has logged on to a second client device associated with the second location.

17. A host computer system, comprising:
a location identification module configured to determine that a user associated with an existing session has moved from a first location associated with a first set of access permissions to a second location associated with a second set of access permissions;
an access permission module configured to apply the second set of access permissions to the existing session based on the determination that the user has moved to the second location; and
a session module configured to allow the user to access the existing session from the second location according to the second set of access permissions.

18. The host computer system of claim 17, further comprising:
a rule detection module configured to retrieve at least one access permission rule associated with the second location from a data store; and
a rule application module configured to apply the at least one access permission rule to the existing session.

19. The host computer system of claim 18, wherein the at least one access permission rule is associated with at least one action, the access permission module being further configured to:
initiate the at least one action with respect to the existing session at the host computer system in response to the determination that the user has moved to the second location.

20. The host computer system of claim 19, wherein the at least one action comprises:
allowing the user to access a system resource based on the second location.

21. The host computer system of claim 19, wherein the at least one action comprises:
preventing the user from accessing a system resource based on the second location.

22. The host computer system of claim 19, wherein the at least one action comprises:
opening an application associated with the session based on the second location.

23. The host computer system of claim 19, wherein the at least one action comprises:
closing an application associated with the session based on the second location.

24. The host computer system of claim 19, wherein:
the location identification module is further configured to authenticate the user at the second location; and
the initiating the at least one action with respect to the existing session at the host computer system occurs during the authentication of the user at the second location.

25. The host computer system of claim 19, wherein the access permission module is further configured to:
prevent the user from accessing the session at the host computer system until after the at least one action has completed.

26. The host computer system of claim 17, wherein the session module is further configured to:
initiate the existing session at the host computer system in response to the user logging on to a first client device.

27. The host computer system of claim 26, wherein location determining module is further configured to:
determine that the user has moved to the second location by determining that the user has logged on to a second client device associated with the second location.
